(19) United States
(12) Patent Application Publication
(10) Pub. No.: US 2005/0033716 A1
(43) Pub. Date: Feb. 10, 2005

(54) Geographic information system having dynamic data model

(76) Inventors: Alex Ambroz, Thornhill, ON (CA); David Young, Whitby (CA); Guy Paterson, Toronto (CA); Ian Mosley, Toronto (CA); Mark Paterson, Toronto (CA)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/481,863

(22) PCT Filed: Jun. 27, 2002
(86) PCT No.: PCT/CA02/00960

(30) Foreign Application Priority Data
Jun. 27, 2001 (CA) 2,355,959

(51) Int. Cl. G06F 7/00

(52) U.S. Cl. 707/1

(57) ABSTRACT

A geographic information system includes a data model server, and computer software executing on a computer server. The data model server includes a business data model and a spatial data model. The business data model includes business attribute data, and the spatial data model includes spatial attribute data associated with the business attribute data. One of the data models includes meta-data defining relationships between the data. The computer software includes a GIS engine in communication with the data models. The GIS engine is configured to manipulate the data attributes in accordance with a user request, and to render the manipulated data on the client terminal.

### FIELD OF THE INVENTION

The present invention relates to a geographic information system. In particular, the present invention relates to a computer system which allows a user to view and modify GIS data over a client terminal.

### BACKGROUND OF THE INVENTION

Geographic information systems (GIS) provide a mechanism for associating and representing data having both a spatial and a tabular data component. GIS solutions are becoming increasingly popular in view of their ability to present a significant amount of data visually, and their ability to organize data based on geographical relevance.

Conventional GIS solutions have included a database of spatial and text data, a GIS server for accessing the data in the database, and one or more user terminals in communication with the GIS server over a local area network (LAN). The user terminals are provided with software which depicts the spatial data in a predetermined manner, typically in the form of a map. The GIS server is provided with software which responds to requests from the user terminals for spatial data, thereby allowing the user to obtain different “aerial” views of selected areas within the map. With the quantity and variety of data available over wide area networks, however, attempts have been made to provide GIS solutions which can tap into diverse (and often incompatible) sources of data.

For instance, Hougaard (U.S. Pat. No. 6,216,130) teaches a geographic-based information technology management system that includes an administrator server, and a user terminal in communication over a network, such as the Internet. The administrator server includes an administrator software application, and the user terminal includes a user software application.

To initialize the GIS, the administrator locates data structures of interest (such as geographic data, tabular data, and application programs for accessing the data). The data structures can be located over the Internet, at the administrator server, or at the user terminal. The administrator then uses the administrator application to compile a series of data references which include address information (eg. URLs) to facilitate subsequent retrieval of the data structures, and display information which specifies the display format and other display properties of the data structure.

The user application includes a user interface generated on the display screen of the user terminal. To view a data structure, the user communicates its selection via the user interface to the administrator application, and receives the appropriate address information and display information in response. The user then establishes communication with the selected data structures using the received address information, and receives the requested data and applications at the user application. The user interface then uses the retrieved applications to generate a map display of the retrieved geographical data, and a graphic/text display of the retrieved tabular data. The applications are also used to communicate changes on the map display (eg. selecting a point of interest) to the graphic/text display (and vice versa).

Although Hougaard provides the administrator and user with some flexibility in assembling and accessing GIS data from a variety of sources of a wide area network, the views available to the user are limited by the data maintained by the data structures. Consequently, if, for example, a user wished to view a map of a city with apartment buildings, and then subsequently without apartment buildings, Hougaard would be unable to provide this solution unless the administrator was able to locate a data structure depicting the city with apartment buildings, and other data structure depicting the city without apartment buildings. Also, the requirement that the client download applications to view the selected data renders the solution cumbersome for use with devices having limited computing resources.

Therefore, there remains a need for a GIS solution which provides the user with increased flexibility in the manner in which the data is presented. In addition, there remains a GIS solution which does not impose a significant computation burden on the rendering client.

### SUMMARY OF THE INVENTION

According to a first aspect of the present invention, there is provided a geographic information system which includes a data model server, and computer software executing on a computer application server. The data model server includes a business data model and a spatial data model. The business data model includes business attribute data, and the spatial data model includes spatial attribute data associated with the business attribute data. One of the data models includes meta-data defining relationships between the data.

The computer software includes a GIS engine in communication with the data models. The GIS engine is configured to manipulate the data attributes in accordance with a user request, and to render the manipulated data on the client terminal.

According to a second aspect of the present invention, there is provided a GIS computer server in communication with a data model server. The data model server includes a business data database and a spatial data database. The business data database includes business attribute data, and the spatial data database includes spatial attribute data associated with the business attribute data. One of the databases includes meta-data defining relationships between the data. The GIS server includes software defining a GIS engine. The GIS engine is in communication with means for rendering the data on a computer terminal, and is configured:
to receive from a client terminal an update to attributes associated with a selected data element from one of the data models;
to update the one data model with the attribute update; and
to update a rendering device on the client terminal in accordance with the attribute update.

According to a third aspect of the present invention, there is provided a method of rendering GIS data, according to the steps of (1) maintaining an attribute data model including at least business attribute data, and a spatial data model including spatial attribute data associated with the business attribute data, the data models including meta-data defining relationships between the data; (2) receiving from a client terminal a selection of the attribute data, and updating at least one of the data models in accordance with the data selection; and (3) formatting the selected data in accordance with the associated meta-data for rendering by the client terminal.

In one implementation of the invention, the GIS engine is configured to render the manipulated data by generating code for effecting a vector graphics update by the client terminal. Also, the data model includes user-specific data, and the GIS engine is configured to effect the graphics update in accordance with the user-specific data.

Since the GIS engine does not merely establish alternate “aerial” views of the spatial data, but instead allows users to update the attribute data of the business and spatial attribute data models, the user is provided with increased flexibility in the manner in which the data can be presented and/or queried. Further, since the rendering of data on the client terminal is performed by the application server, rather than the client terminal, the computation burden on the rendering client is limited.

### BRIEF DESCRIPTION OF THE DRAWINGS

The present invention will now be described, by way of example only, with reference to the accompanying drawings, in which:

FIG. 1 is a schematic view of the geographic information system, according to the present invention, depicting the client terminals, the spatial model server, the business model server, the user interaction server, and the GIS data server;

FIG. 2 is a schematic view of the user interaction server, depicting the user interaction engine;

FIG. 3 is a schematic view of the GIS data server, depicting the GIS engine;

FIG. 4 is a representative view of a graphical user interface implemented by the GIS engine on one of the client terminals;

FIG. 5 is a flow chart depicting the general operation of the geographic information system; and

FIGS. 6a, 6b and 6c together define a flow chart depicting the detailed operation of the geographic information system.

### DETAILED DESCRIPTION OF THE PREFERRED EMBODIMENT

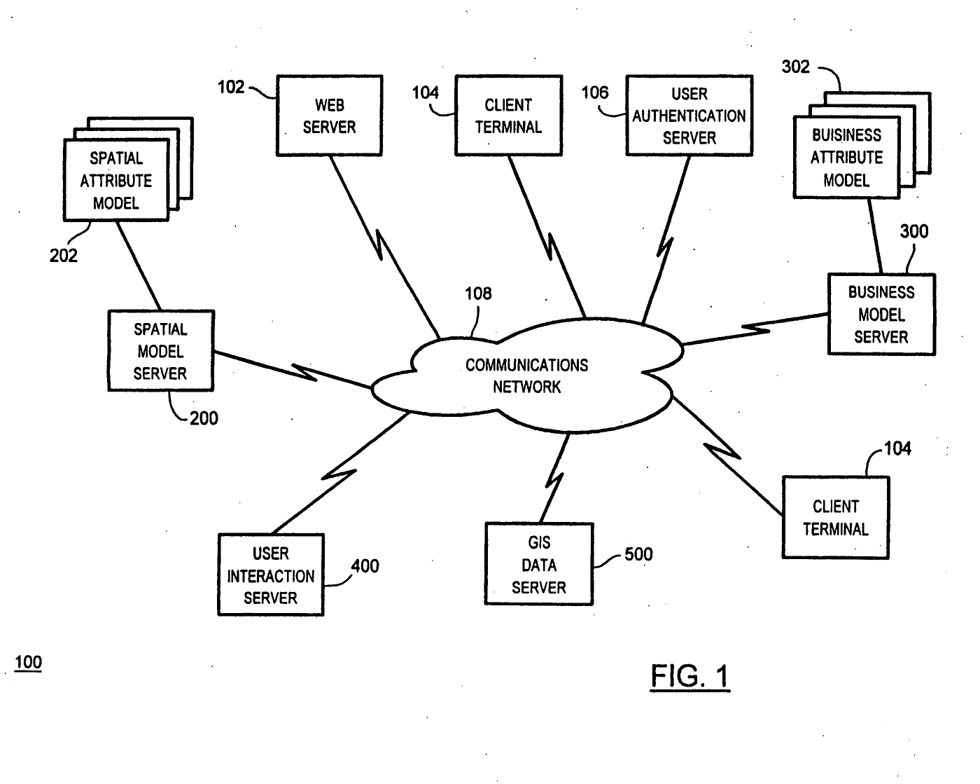

Turning to FIG. 1, a geographic information system, denoted generally as 100, is shown comprising a web server 102, a number of client terminals 104, a user authentication server 106, a spatial model server 200, a business model server 300, a user interaction server 400, a GIS data server 500, and a communications network 108 interconnecting the web server 102, the client terminals 104, the user authentication server 106, the spatial model server 200, the business model server 300, the user interaction server 400 and the GIS data server 500. Preferably, the communications network 108 comprises a wide area network, such as the Internet, however the communications network 108 may also comprise a local area network. Further, the communications network 108 can comprise a wired network, a wireless network or a combination of wired and wireless networks.

Although the web server 102, the spatial model server 200, the business model server 300, the user interaction server 400 and the GIS data server 500 are depicted as separate computer servers, the functions of the web server 102, the spatial model server 200, the business model server 300, the user interaction server 400 and the GIS data server 500 can be implemented on a single computer server. Alternately, the geographic information system 100 can be implemented using fewer than the number of servers depicted by combining the functions of any of the web server 102, the spatial model server 200, the business model server 300, the user interaction server 400 and the GIS data server 500. However, for load balancing, preferably the geographic information system 100 is implemented as shown in FIG. 1.

The web server 102 is implemented as a computer server which is accessible by the network terminals 104 over the network 108, and provides the network terminals 104 with HTML pages via HTTP. The web server 102 can be implemented using conventional platforms, such as IIS, iPlanet and Apache. However, preferably the web server 102 also includes software which redirects all requests for .cfm pages to the user interaction server 400.

The client terminals 104 can be implemented as personal communication devices, such as personal computers, wireless-enabled personal data assistants, and wireless telephones. Each client terminal 104 includes an input device (such as a keyboard or mouse), and a visual rendering device (such as a LCD or CRT). In addition, each client terminal 104 includes web browser software which is capable of receiving address data (such as Uniform Resource Locator data), and is capable of processing received HTML pages and rendering graphics and text on the rendering device. Suitable web browser software includes Microsoft Internet Explorer and Netscape Communicator.

The user authentication server 106 is configured to determine whether a user of a client terminal 104 is authorized to access the geographic information system 100. Typically, the user authentication server 106 is implemented as a Lightweight Directory Access Protocol (LDAP) server, and includes username/password data for authenticating each user of a client terminal 104, and a user ID (associated with the username/password data) for use by the user interaction server 400 to establish data access privileges to the data maintained in the spatial model server 200 and the business model server 300.

The spatial model server 200 is a computer database server which maintains a spatial attribute data model database 202. The spatial model database 202 is implemented using database platforms capable of supporting spatial data, such as AutoDesk, ESRI and Oracle 9i Spatial. The spatial attribute data model database includes records having spatial data (eg. longitude/latitude co-ordinates for a road), and spatial attributes (eg. road type, road width). Hereinafter the phrase “spatial attribute data” will be used to refer to both spatial data and spatial attributes.

In addition to the spatial attribute data, each record of the spatial attribute data model database 202 includes a feature ID uniquely associated with the spatial attribute data. As will be explained below, the geographic information system 100 uses the feature ID to allow user's to select spatial data items depicted on their client terminal 104.

The business model server 300 is a computer server which maintains a business attribute data model database 302. The business attribute data model database 302 includes records having business attribute data such as business information (eg. Dunn and Bradstreet data) and demographic data; and client data such as user ID, user profile/preferences data, customer data, sales volume data, store location data, and marketing results data.

The business model database 302 also includes meta-data which defines relationships between the spatial attribute data and the business attribute data. The meta-data is also used by the GIS data server 500 to associate the spatial attribute data with the business attribute data. Also, the meta-data is used by the user interaction server 400 to create user interface controls on the rendering device of the client terminals 104 and to enforce security. The user interaction server 400 also saves user preferences and maintains a user log-in history in the meta-data.

The business attribute data model database 302 can be implemented, either as a flat file or a relational database, using conventional database platforms, such as such as Oracle, DB2, SQL Server and Sybase. Although the spatial attribute data model database 202 and the business attribute data model database 302 are shown as being implemented on separate computer database servers, the spatial attribute data model database 202 and the business attribute data model database 302 can be implemented on a common database server using a platform capable of supporting both and spatial data, such as Oracle 9i Spatial.

In addition to the business attribute data model database 302, the business model server 300 maintains a code base which comprises code defining procedures and rules governing the movement of data into and out of the spatial attribute data model database 202 and the business attribute data model database 302. All requests for data from the spatial attribute data model database 202 and the business attribute data model database 302 are passed to the code base for processing in accordance with the meta-data.

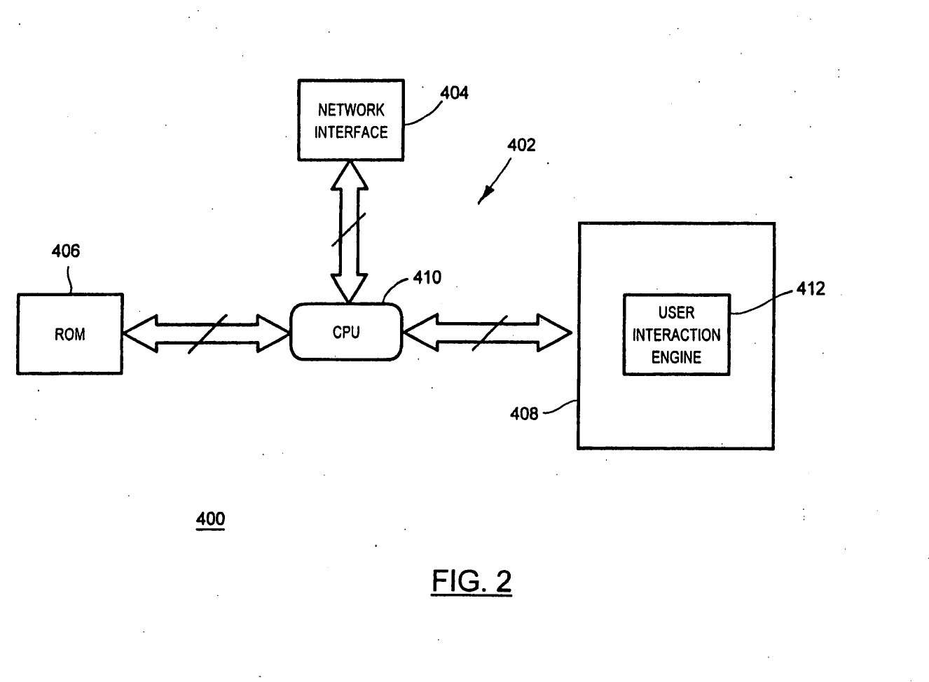

The user interaction server 400 is implemented as a computer server which communicates with the web server 102 over the network 108. As shown in FIG. 2, the user interaction server 400 includes a data processor 402, and a network interface 404 which interfaces the data processor 402 with the network 108. The data processor 402 includes a non-volatile memory (ROM) 406, a volatile memory (RAM) 408, and a central processing unit (CPU) 410 in communication with the ROM 406 and the RAM 408. The ROM 406 may be implemented as a magnetic memory, such as a hard drive, an optical memory, such as a CD-ROM, or an electronic memory. The ROM 406 carries processing instructions for the CPU 410 which establish in the RAM 408 a user interaction engine 412.

The user interaction engine 412 is configured to capture data received from the web server 102 via HTTP, and to transmit the data to the GIS data server 500 using a protocol implemented by the GIS data server 500. Conversely, the user interaction engine 412 is also configured to capture data and code received from the GIS data server 500, and to transmit the data/code to the web server 102 via HTTP. As will be apparent, if the GIS data server 500 is configured to communicate via HTTP, the functions of the user interaction engine 412 can be incorporated into the GIS data server 500.

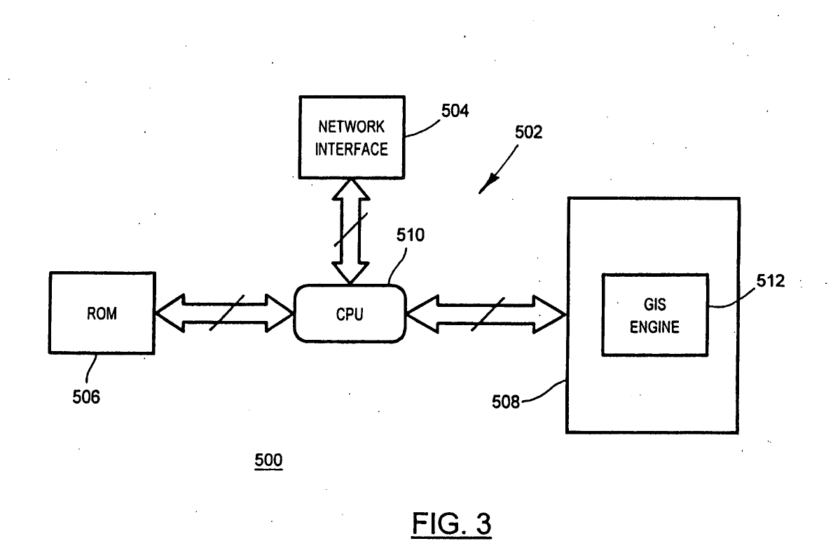

The GIS data server 500 is implemented as a computer server which communicates with the user interaction server 400 over the network 108. As shown in FIG. 3, the GIS data server 500 includes a data processor 502, and a network interface 504 which interfaces the data processor 502 with the network 108. The data processor 0.502 includes a non-volatile memory (ROM) 506, a volatile memory (RAM) 508, and a central processing unit (CPU) 510 in communication with the ROM 506 and the RAM 508. The ROM 506 may be implemented as a magnetic memory, such as a hard drive, an optical memory, such as a CD-ROM, or an electronic memory. The ROM 506 carries processing instructions for the CPU 510 which establish in the RAM 508 a GIS engine 512.

The GIS engine 512 is configured to create a user interface 514 on the rendering device of the client terminals 104 in accordance with the parameters set out in the meta-data. Also, the GIS engine 512 is configured to display data from the spatial data model database 202 and the business model database 302 in the user interface 514, in accordance with the parameters set out in the meta-data. To do so, preferably the GIS engine 512 includes an applications program interface to AutoDesk's MapGuide software, to thereby depict spatial data in the user interface 514 in vector-based format, based on the spatial attribute data contained in the spatial attribute data model database 202. However, the GIS engine 512 may make use of alternate software applications to render the spatial data, including MapInfo MapInfo and ESRI ArcIMS.

The GIS engine 512 is also configured to update/manipulate the spatial and business data attributes in the attribute data model databases 202, 302 in accordance with user requests received from the client terminals 104 (via the user interface 514). In addition, the GIS engine 512 is configured to perform spatial operations (such as locating a point on a polygon, finding the nearest point to a line etc.) on the spatial attribute data in the spatial attribute data model database 202. Preferably, the GIS engine 512 employs Allaire's Cold Fusion Server to manipulate the spatial and business data attributes, and to create JavaScript for the rendering of the user interface 514.

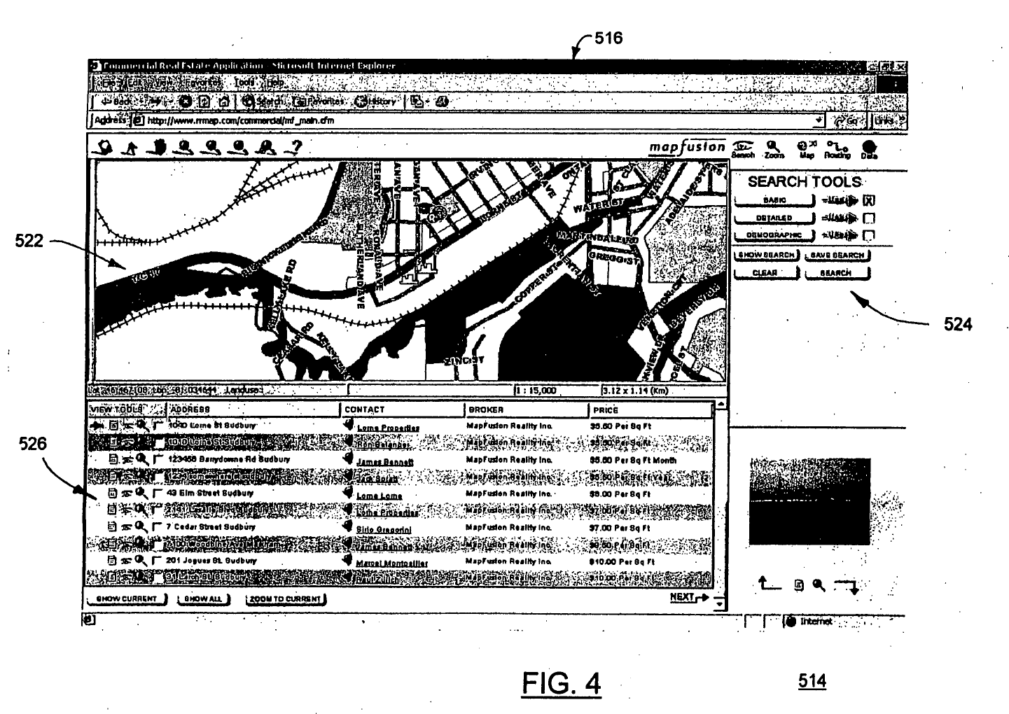

A representative user interface 514 is shown in FIG. 4. The user interface 514 includes a primary application window 516, a detailed report window (not shown), and a data entry window (not shown). The primary application window 516 is the default window rendered for the user of the client terminal 104. The detailed report window is launched from a control button in the primary application window 516 or by selected an object in the primary application window 516 which the user requires additional information. The data entry window is launched when the user of the client terminal is required to enter data which cannot be conveniently entered via the primary application window 516.

The primary application window 516 includes a map window region 522, a data access window region 524, and a row report window region 526. The map window region 522 depicts spatial data and is used to view and select spatial data items for further analysis. The data access window region 524 includes control tools which allow the user of the client terminal 104 to access and manipulate with the data items in the spatial attribute data model database 202 and the business attribute data model database 302. Typically, the data access window region 524 includes menu items or buttons associated with each different type of data item (eg. churches, schools, hotels).

The row report window region 526 provides the user with a table whose row elements correspond with the spatial data items in the map window region 522. Each row element corresponds with a selected spatial data item. For instance, houses for sale would be depicted in the map window region 522 with an icon, and would have a corresponding row entry in the row report window region 526. Similarly, if a spatial data item is highlighted in the map window region 522, the corresponding row entry in the row report window region 526 would also be highlighted (and vice versa).

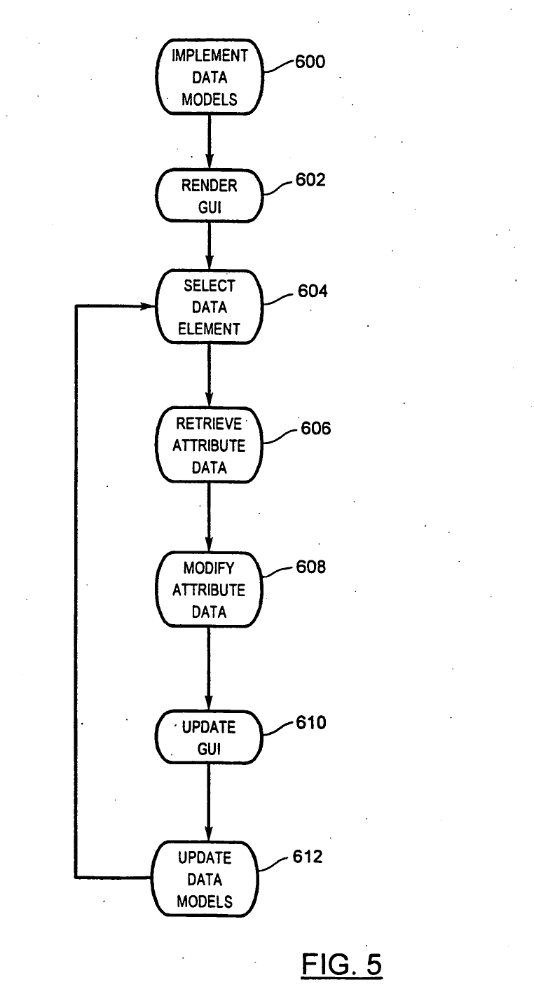

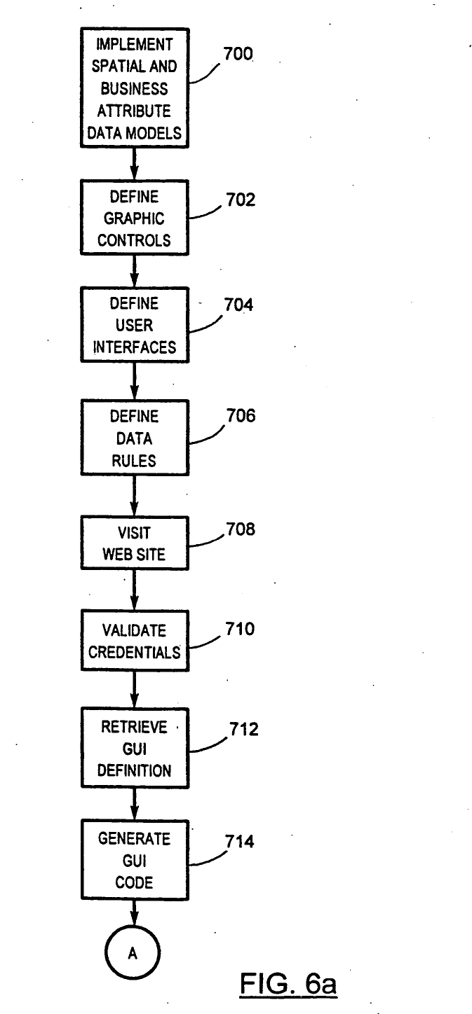

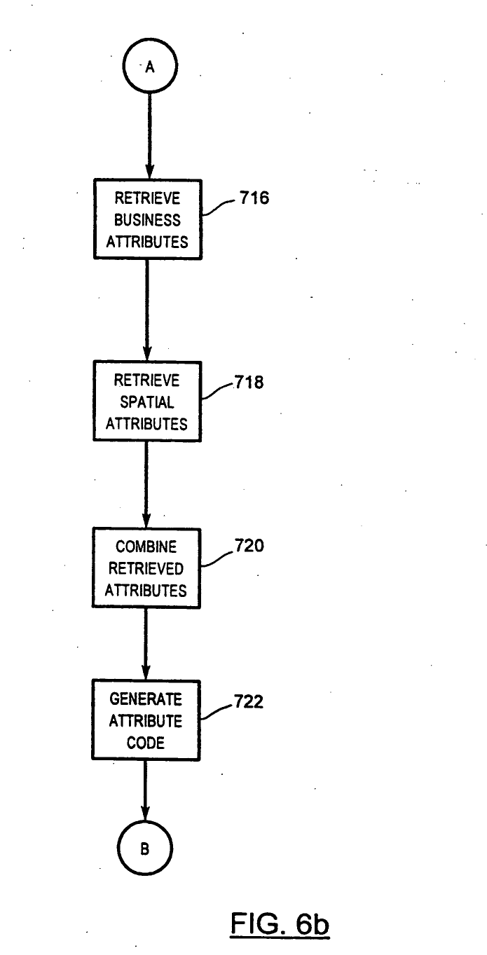

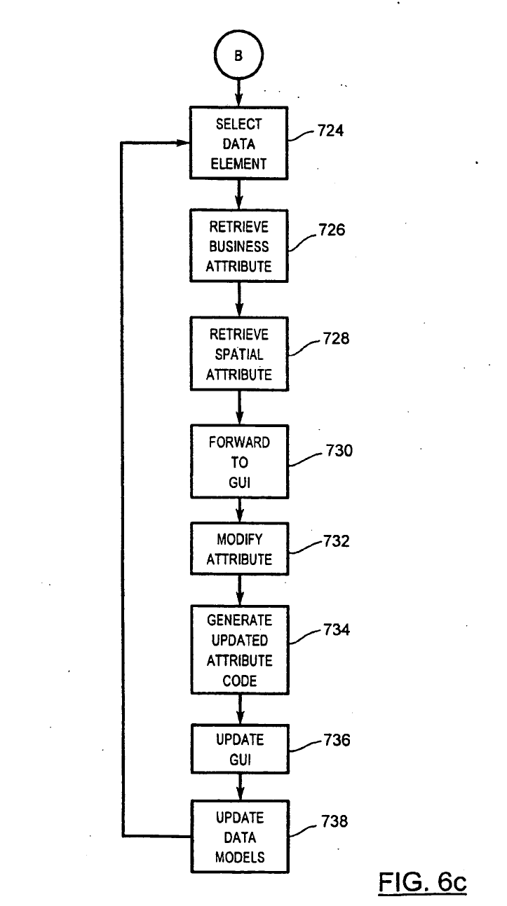

The operation of the geographic information system 100 will now be described in general with reference to FIG. 5, followed by a detail description with reference to FIG. 6. At step 600, a system administrator implements a spatial attribute data model and a business attribute data model. The spatial attribute data model includes spatial attribute data, and the business attribute data model includes business attribute data, and client data. The system administrator also includes in the business attribute data model meta-data defining the relationships between the spatial attribute data, the business attribute data and the client data.

After the data models are defined, at step 602 the GIS engine 512 generates the code necessary to depict the user's user interface 514, and to depict any default data (retrieved from the attribute data model databases 202, 302) in the appropriate windows of the user's user interface 514. The GIS engine 512 then transmits the generated code to the user interaction engine 412 for transmittal to the web server 102. Upon receipt of the generated code, the web server 102 transmits the code to the client terminal 104 for rendering on the user's rendering device.

If the user of the client terminal 104 wishes to modify one of the displayed data elements, or its associated attributes, at step 604 the user selects the data element via the user interface 514. After the desired data element(s) is selected, the user interface 514 transmits the feature ID of the selected data element to the user interaction engine 412 (via the web server 102). The user interaction engine 412 responds to the feature ID by querying the GIS engine 512 for the attribute data associated with the selected data element. At step 606, the GIS engine 512 extracts the attribute data from the attribute data model databases 202, 302, and then forwards same to the user interaction engine 412. The user interaction engine 412 then forwards the retrieved attribute data to the client terminal 104 (via the web server 102). The retrieved attribute data is then displayed on the rendering device of the client terminal 104.

At step 608, the user of the client terminal 104 modifies the retrieved attribute data using the user interface 514. After the selected data item(s) are updated, the user interface 514 transmits the updated attribute data back to the user interaction engine 412 (via the web server 102). The user interaction engine 412 forwards the updated attribute data to the GIS engine 512. At step 610, the GIS engine 512 generates the code necessary to depict the selected data element in the appropriate windows of the user's user interface 514, in accordance with the updated attribute data. The GIS engine 512 then forwards the updated code to the user interaction engine 412 for transmittal to the web server 102. Upon receipt of the generated code, the web server 102 transmits the code to the client terminal 104 for rendering on the user's rendering device. Then, at step 612, the GIS engine 512 updates the attribute data model databases 202, 302 with the updated attribute data.

The operation of the geographic information system 100 will now be described in detail with reference to FIG. 6. At step 700, a system administrator deploys a spatial attribute data model database 202 and a business attribute data model database 303, and then implements a spatial attribute data model and a business attribute data model respectively in the spatial attribute data model database 202 and the business attribute data model database 303. As described above, the spatial attribute data model includes spatial attribute data, and the business attribute data model includes business attribute data, and client data. The system administrator also defines the relationships between the spatial attribute data, the business attribute data and the client data in the meta-data.

At step 702, the system administrator defines the graphic control elements (eg. menus, buttons, dialog boxes etc.) in the meta-data, which will be used by the user interaction server 400 to create user interface controls on the rendering device of the client terminals 104. Then, based on the client data, at step 704 the system administrator defines in the meta-data the default appearance of the user interface 514 for each user of a client terminal 104, and the default format for displaying the data in the attribute data model databases 202, 302 on the rendering device for each client terminal user. In this manner, the geographic information system 100 is able to generate a customized display of data for each user in accordance with each user's business and preferences.

At step 706, the system administrator defines in the code base the procedures and rules governing the movement of data into and out of the spatial attribute data model database 202 and the business attribute data model database 302. Typically, the rules reference the client data, so that the user interaction engine 412 can restrict access and updates to selected data items in the attribute data model databases 202, 302 on a per user-basis. The system administrator also provides the user authentication server 106 with username/password data and user class data for each user authorized to use the geographic information system 100. After the attribute data model databases 202, 302 and the user authentication server 106 have been populated, the geographic information system 100 is ready to receive requests from client terminals 104 for access to the data contained in the attribute data model databases 202, 302.

To access the data from the attribute data model databases 202, 302, at step 708 a user accesses the web server 102 (using the web browser software installed on the user's client terminal 104) by specifying the URL of the web server 102 and a .cfm page stored on the web server 102. Upon receipt of the .cfm page request from the client terminal 104, the web server 102 transparently redirects the user's request to the user interaction engine 412.

The user interaction engine 412 then prompts the user for the user's username and password, and validates the provided credentials using the user authentication server 106, at step 710. If the credentials provided by the user are valid, the user authentication server 106 provides the user interaction engine 412 with the user's user ID. Alternately, the geographic information system 100 may dispense with the user authentication server 106, and validate the provided credentials by referring to username/password data stored in the business attribute data model database 302.

Upon receipt of the user ID, the user interaction engine 412 transmits the user ID to the GIS engine 512 (together with a login request command) for the code necessary to render the user's user interface 514. Upon receipt of the user ID, at step 712 the GIS engine 512 retrieves from the business attribute data model database 302 the meta-data defining the user's user interface 514. At step 714, the GIS engine 512 generates the HTML and JavaScript code necessary to construct the user's user interface 514, and then transmits the generated code to the user interaction engine 412. The user interaction engine 412 then transmits the generated code to the client terminal 104 (via the web server 102) for rendering by the web browser of the client terminal 104.

At step 716, the user interaction engine 412 queries the GIS engine 512 for data to be displayed in the user interface 514. The query is passed by the GIS engine 512 to the code base for further processing. Upon receipt of the query, the code base determines the user's privileges and defaults from the client data and the meta-data, and then extracts from the business attribute data model database 302 data to be displayed in the user's user interface 514, as determined by the user's defaults. The code base passes the retrieved data to the GIS engine 512, together with the meta-data defining the relationship between the retrieved business attribute data and the spatial attribute data stored in the spatial attribute data model database 202.

At step 718, the GIS engine 512 queries the spatial attribute data model database 202 for the spatial attribute data associated with the retrieved business attribute data. Upon receipt of the retrieved spatial attribute data (including the associated feature IDs), the GIS engine 512 assembles the retrieved spatial attribute data with the retrieved business attribute data, at step 720. The GIS engine 512 generates the HTML and JavaScript code necessary to depict the retrieved data in the appropriate windows of the user's user interface 514, at step 722, and then forwards the generated code to the user interaction engine 412. The user interaction engine 412 then transmits the generated code to the client terminal 104 (via the web server 102) for rendering by the web browser of the client terminal 104.

Subsequently, if the user wishes to modify any attribute of a displayed data item, at step 724 the user selects the desired data item by highlighting the data item, in the map window region 522, the data access window region 524 or the row report window region 526, using the user's input device. For instance, if the user was viewing the map of a city on the client terminal 104, typically the data access window region 524 of the user interface 514 would include buttons or menu items associated with each map element (eg. roads, waterways, apartment buildings, office buildings, churches, hospitals, airports etc.) If the user wanted to view the city with all waterways being depicted, at step 724 the user would activate the menu or button associated with waterways. Alternately, if the user wanted to modify the number of occupants associated with one of the apartment buildings, at step 724 the user could either select the apartment building via the map window region 522 or the row report window region 526.

The user interface 514 transmits the feature ID(s) of the selected data items to the user interaction engine 412. The user interaction engine 412 then queries the GIS engine 512, at step 726, for the attribute data associated with the selected data item. The query is passed by the GIS engine 512 to the code base for further processing. Upon receipt of the query, the code base determines the user's privileges from the client data and the meta-data If the user is allowed access to the attribute data for the selected data item, the code base extracts the associated business attribute data from the business attribute data model database 302. The code base passes the retrieved data to the GIS engine 512.

The GIS engine 512 queries the spatial attribute data model database 202 for the spatial attribute data associated with the retrieved business attribute data, at step 728. Upon receipt of the retrieved spatial attribute data, the GIS engine 512 generates the code necessary to highlight the selected data item in the map window region 522, and to display its business attributes in the row report window region 526. The GIS engine 512 then forwards the generated code to the user interaction engine 412, at step 730. The user interaction engine 412 then transmits the generated code to the client terminal 104 (via the web server 102) for rendering by the web browser of the client terminal 104.

At step 732, the user alters the attribute data as desired, using the input device. For instance, if the user wanted to view the city with all waterways being depicted, at step 732 the user would activate the button in the data access window region 524 signifying inclusion of all waterway data elements. Alternately, if the user wanted to modify the number of occupants associated with one of the apartment buildings, at step 732 the user would enter the updated occupancy data in the row report window region 526.

After the user finishes updating the attribute data for the selected data item(s), the user interface 514 transmits the updated attribute data to the user interaction engine 412. Upon receipt of the updated attribute data, the user interaction engine 412 forwards the updated attribute data to the GIS engine 512. At step 734, the GIS engine 512 generates the HTML and JavaScript code necessary to depict the selected data item in the appropriate windows of the user's user interface 514, in accordance with the updated attribute data, and then forwards the generated code to the user interaction engine 412. The user interaction engine 412 then transmits the generated code to the client terminal 104 (via the web server 102) for rendering by the web browser of the client terminal 104.

At step 736, the GIS engine 512 then passes updated attribute data to the code base for storage in the attribute data model databases 202, 302. Upon receipt of the query, the code base determines the user's privileges from the client data and the meta-data. If the user is allowed access to the attribute data for the selected data item, the code base stores the updated business attribute data (if any) in the business attribute data model database 302. The GIS engine 512 also stores the updated spatial attribute data (if any) in the spatial attribute data model database 202, at step 738.

Thus, if the user wanted to view the city with all waterways being depicted, and subsequently without any waterways being depicted, the map window region 522 could be updated without having to maintain one map image depicting the city with the waterways, and another map image depicting the city without the waterways. Similarly, if the user wanted to view the city only with apartment buildings having a minimum number of occupants, the map window region 522 could be modified as the number of occupants changed, without having to maintain one map image depicting the city with one group of apartment buildings, and another map image depicting the city with another group of apartment buildings. As will be apparent, the mechanism employed by the geographic information system 100 for accessing and updating the attribute data provides the user with enhanced flexibility in the manner in which spatial and business attribute data can be rendered.

The present invention is defined by the claims appended hereto, with the foregoing description being illustrative of a preferred embodiment of the invention. Those of ordinary skill may envisage certain modifications to the described embodiment which, although not explicitly disclosed herein, do not depart from the scope of the invention, as defined by the appended claims.

1. A geographic information system comprising:
a data model server including a business data model and a spatial data model, the business data model including business attribute data, the spatial data model including spatial attribute data associated with the business attribute data, one of the data models including meta-data defining relationships between the data; and
computer software executing on the computer server, the computer software including a GIS engine in communication with the data models, the GIS engine being configured to manipulate the data attributes in accordance with a user request and to render the manipulated data on the client terminal.

2. The geographic information system according to claim 1, wherein the GIS engine is configured to render the manipulated data by generating code for effecting a vector graphics update by the client terminal.

3. The geographic information system according to claim 2, wherein the data model includes user-specific data, and the GIS engine is configured to effect the graphics update in accordance with the user-specific data.

4. A GIS computer server in communication with a data model server, the data model server including a business data database and a spatial data database, the business data database including business attribute data, the spatial data database including spatial attribute data associated with the business attribute data, one of the databases including meta-data defining relationships between the data, the GIS server including software defining a GIS engine, the GIS engine being configured:
to receive from a client terminal an update to attributes associated with a selected data element from one of the data models;
to update the one data model with the attribute update; and
to update a rendering device on the client terminal in accordance with the attribute update.

5. The GIS server according to claim 4, wherein the GIS engine is configured to update the rendering device by generating code for effecting a vector graphics update by the client terminal.

6. The GIS server according to claim 5, wherein the data model includes user-specific data, and the GIS engine is configured to effect the graphics update in accordance with the user-specific data.

7. A method of rendering GIS data, comprising the steps of:
maintaining an attribute data model including at least business attribute data, and a spatial data model including spatial attribute data associated with the business attribute data, the data models including meta-data defining relationships between the data;
receiving from a client terminal a selection of the attribute data, and updating at least one of the data models in accordance with the data selection; and
formatting the selected data in accordance with the associated meta-data for rendering by the client terminal.

8. The method according to claim 7, wherein the formatting step comprises generating code for effecting a vector graphics update by the client terminal.

9. The method according to claim 8, wherein the data model includes user-specific data, and the formatting step comprises effecting the graphics update in accordance with the user-specific data.

10. A computer-readable medium containing processing instructions thereon for a computer which, when executed by the computer, cause the computer to perform the steps of:
maintaining an attribute data model including at least business attribute data, and a spatial data model including spatial attribute data associated with the business attribute data, the data models including meta-data defining relationships between the data;
receiving from a client terminal a selection of the attribute data, and updating at least one of the data models in accordance with the data selection; and
formatting the selected data in accordance with the associated meta-data for rendering by the client terminal.

11. The computer-readable medium according to claim 10, wherein the formatting step comprises generating code for effecting a vector graphics update by the client terminal.

12. The computer-readable medium according to claim 11, wherein the data model includes user-specific data, and the formatting step comprises effecting the graphics update in accordance with the user-specific data.
